(19) United States
(12) Patent Application Publication
(10) Pub. No.: US 2010/0078920 A1
(43) Pub. Date: Apr. 1, 2010

(54) Air bag door

(75) Inventors: Nobuhiro Terai, Aichi-ken (JP); Chiharu Totani, Aichi-ken (JP); Takahiko Sato, Aichi-ken (JP); Masaya Kometani, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/585,408

(22) Filed: Sep. 15, 2009

(30) Foreign Application Priority Data
Sep. 29, 2008 (JP) 2008-251009
Dec. 26, 2008 (JP) 2008-332475
Jul. 30, 2009 (JP) 2009-177220

(51) Int. Cl. B60R 21/20

(52) U.S. Cl. 280/728.3

(57) ABSTRACT

A resin made air bag door includes a main portion having a welding face to be attached to an inner surface of a dashboard having a thickness of 2.0 mm or less at a welding area, by vibration welding, a plurality of welding ribs formed on the welding face in a vibrating direction of the vibration welding, and at least one bridging rib formed on the welding face of the main portion and extending in a direction crossing across the welding ribs. The plurality of welding ribs includes a welding portion to be melted at the time of vibration welding and a bonding portion to be bonded to the inner surface of the dashboard, remaining at the time of vibration welding. A width of a tip end of the bonding portion is equal to or less than 3 mm.

### INCORPORATION BY REFERENCE

The present invention is based on Japanese Patent Application No. 2008-251,009, filed on Sep. 29, 2008, Japanese Patent Application No. 2008-332,475, filed on Dec. 26, 2008, and on Japanese Patent Application No. 2009-177,220, filed on Jul. 30, 2009, the entire contents of which are incorporated herein by reference.

### BACKGROUND OF THE INVENTION

1. Field of the Invention

The present invention relates to an air bag door made of resin constituting a part of an air bag device mounted on a vehicle, and more particularly to the air bag door made of resin to be welded to a resin made dashboard of the vehicle by means of vibration welding.

2. Description of the Related Art

An air bag device equipped on a vehicle usually has an air bag door containing an air bag unit therein. The air bag door is made of resin, and attached to an inner surface of the dashboard on the vehicle. The air bag door has a retainer in a shape of an open container and a door portion. The retainer and the door portion are provided in one united body. The air bag unit is contained in the retainer at the backside of the door portion. The door portion is plate shaped, and is welded to an inner surface of the resin-made dashboard by vibration welding. The door portion normally closes an opening of the retainer and opens the retainer upon air bag inflation (activation of the air bag unit) by swinging or deforming.

The air bag door has a plurality of ribs (welding ribs) for vibration welding. This structure is shown in the patent documents 1 (Patent Document 1: Japanese Patent Laid-Open (KOKAI) No. 2001-294114) and 2 (Patent Document 2: Japanese Patent Laid-Open (KOKAI) No. 2004-338092). The air bag door is fixed to the inner surface of the dashboard by vibration welding at the ribs. When an air bag inflates, a great impact is applied on the air bag door.

On this account, the resin material forming the air bag door has to have a sufficient strength not to be broken by the impact received thereon. For example, TPO (an abbreviation of “thermoplastic olefin”) is used for the air bag door material due to its sufficient strength or rigidity against the impact. On the other hand, a resin material forming the dashboard has to be light in weight and yet has to have a high tensile performance. For that reason, PP (an abbreviation of “polypropylene”) is used for the material of the dashboard. As mentioned above the materials used for the air bag door and the dashboard are different in various properties such as for example, a linear expansion coefficient. Therefore, due to the difference in linear expansion coefficient, uneven surface may be formed on the welding surface of the dashboard due to a thermal contraction after the vibration welding. Thinner the thickness of the dashboard particularly at the welding portion, Greater the unevenness on the welding surface of the dashboard becomes.

Need thus exists for an air bag door which is not susceptible to the drawback mentioned above.

### SUMMARY OF THE INVENTION

According to an aspect of the invention, the resin made air bag door comprises a main portion having a welding face to be attached to an inner surface of a dashboard by vibration welding, the thickness of the dashboard being equal to or less than 2.0 mm at a welding area corresponding to the welding face of the main portion, a plurality of welding ribs formed on the welding face in a vibrating direction of the vibration welding and at least one bridging rib formed on the welding face of the main portion and extending in a direction crossing across the plurality of welding ribs. Each of the plurality of welding ribs includes a welding portion to be melted at the time of vibration welding and a bonding portion to be bonded to the inner surface of the dashboard remaining at the time of vibration welding, wherein a width of a tip end of the bonding portion is equal to or less than 3 mm and the bridging rib is integrally formed with mutually neighboring welding ribs.

### BRIEF DESCRIPTION OF THE DRAWINGS

The air bag door according to the present invention will be explained with references to the attached drawings, in which:

FIG. 1 is a perspective view schematically expressing the air bag door as a first preferred embodiment of the present invention, i.e., Embodiment 1;

FIG. 2 is a partially enlarged perspective view pinpointed on an essential part of the air bag door of Embodiment 1;

FIG. 3 is a partially enlarged plan view schematically showing an essential part of the air bag door of Embodiment 1, seen from the dashboard side;

FIG. 4 is a perspective view schematically showing the air bag door according to Embodiment 2 of the invention;

FIG. 5 is a perspective view schematically expressing the air bag door according to Embodiment 3 of the invention;

FIG. 6 is a partially enlarged plan view schematically showing an essential part of the air bag door of Embodiment 3, seen from the dashboard side;

FIG. 7 is a partially enlarged plan view schematically showing an essential part of the air bag door according to Embodiment 4, seen from the dashboard side;

FIG. 8 is a partially enlarged plan view showing an essential part of the air bag door according to Comparative example 1, seen from the dashboard side;

FIG. 9 is a partial enlarged plan view showing an essential part of the air bag door according to Comparative example 2, seen from the dashboard side;

FIG. 10 is a partially enlarged plan view showing an essential part of the air bag door according to Comparative example 3, seen from the dashboard side;

FIG. 11 is a partial enlarged plan view showing an essential part of the air bag door as a Comparative example 4, seen from the dashboard side;

FIG. 12 schematically shows a peeling strength measurement test with eyebolts and nuts installed on a welded test piece;

FIG. 13 schematically shows an explanatory view showing a welding width of a welding rib of the air bag door as one of the embodiments of the invention;

FIG. 14 is a view similar to FIG. 13, but showing a welding width of the air bag door welded to the dashboard of a vehicle;

FIG. 15 is a front view or a plan view schematically showing the air bag door under the dashboard;

FIG. 16 is a cross-sectional view taken along the A-A line in FIG. 15; and

FIG. 17 is a cross-sectional view similar to FIG. 16, but showing the dashboard being broken.

### DETAILED DESCRIPTION OF THE PREFERRED EMBODIMENTS

The air bag door according to the present invention will be explained with references to the attached drawings.

### First Preferred Embodiment

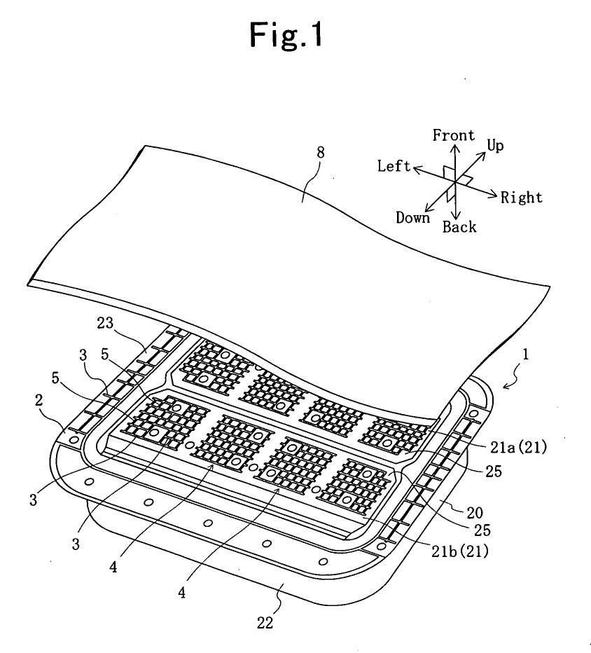

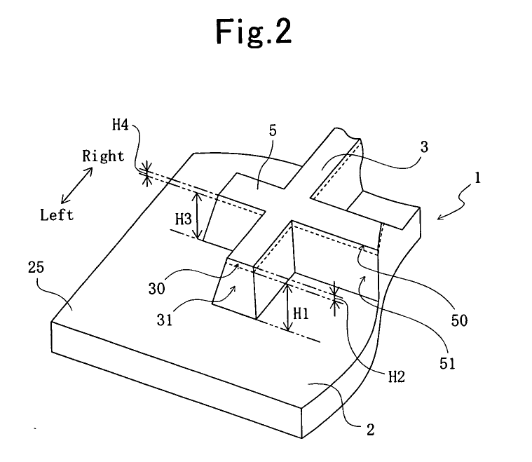

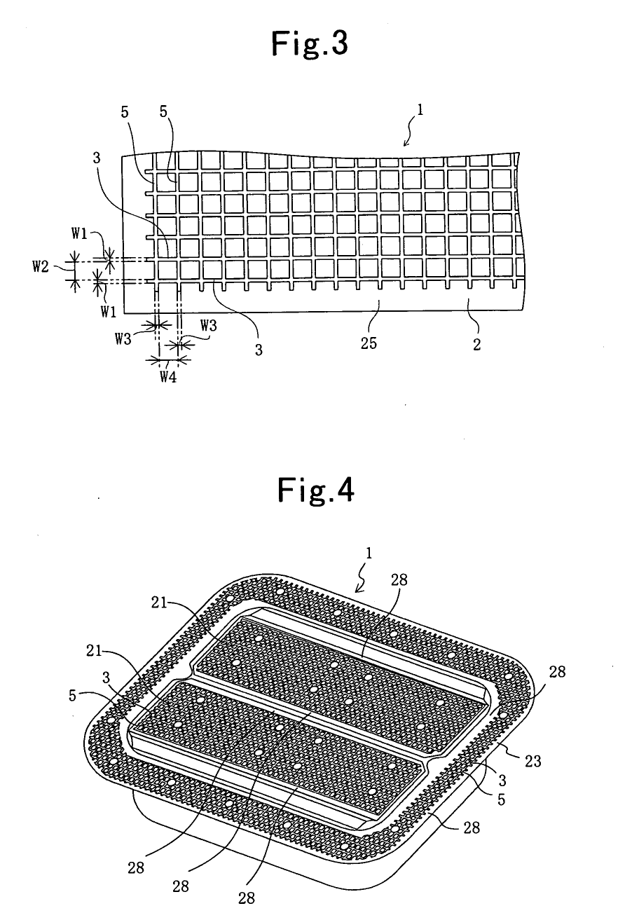

FIG. 1 shows a perspective view schematically showing the air bag door 1 according to a first preferred embodiment of the present invention, i.e., Embodiment 1. FIG. 2 shows an essential part enlarged in a perspective view of the air bag door 1 as Embodiment 1. FIG. 3 shows the essential part expanded in a plan view of the air bag door 1, schematically shown from the dashboard side.

In the following description, Up, Down (or Lower), Left, Right, Front and Back stand for the same shown in FIG. 1. In addition, the direction of the vibration in the vibration welding process is set out along the right and left direction.

The length of the welding ribs 3 is referred along the right and left direction. The height of welding ribs 3 is referred to the length along the front and back direction. The width of the welding ribs is referred to the length of the up and down direction.

As shown in FIG. 1, the air bag door 1 of the embodiment has a main portion 2 and the plurality of welding ribs 3. The air bag door 1 is made of TPO (i.e., thermoplastic olefin) resin material. The main portion 2 has a retainer 20 and a pair of door portions 21 (i.e., one door portion 21a and the other door portion 21b).

Each door portion 21a, 21b is formed in a shape of a door panel, and is hinged to the retainer 20. The retainer 20 and the door portion 21 are integrally formed by resin molding. The retainer 20 includes an open container 22 and a flange 23.

The open container 22 is formed in a shape of an open box with round corners, and an opening of the open container 22 is facing in a front direction. The open container 22 and the flange 23 are molded integrally. The flange is molded in a rectangular shape with round corners, and is fixed to the open container 22 around an edge of the opening 7.

The retainer 20 is a container or a box, and an air bag unit (not shown in the figure) is contained in the retainer 20.

Each door portion 21a, 21b is in a shape of a rectangular plate. The door portion 21a is connected to the upper internal edge of the flange 23. The other door portion 21b is connected to the lower internal edge of the flange 23. Thus, the door portions 21a, 21b are hinged to the flange 23 to close the opening 7 of the open container 22. In case of air bag inflation, the door portions 21 can be flapped out around the hinges along the inner edges of the retainer 20.

The air bag door 1 is arranged onto a certain area on an inner surface of the dashboard 8, as shown in FIG. 1. The front of the flange 23 and the front of the door portions 21a, 21b are attached to the inner surface of the dashboard 8. The front side of the door portions 21 in the air bag door 1 serves as a welding face 25. A plurality of combined rib portions 4 is formed on the front side (i.e. the welding face 25) of each door portion 21.

Each combined rib portion 4 is integrally molded with the plurality of welding ribs 3 and the plurality of bridging ribs 5 crossing each other in a shape of a grid (lattice). The welding ribs 3 are provided along the right and left direction, and the bridging ribs 5 are provided along the up and down direction. The welding ribs 3 and the bridging ribs 5 are crossing perpendicular to each other. The cross-section of the welding ribs 3 is in a tapered shape of a trapezoid. Likewise, the cross-section of the bridging ribs 5 is in the tapered shape of the trapezoid.

As shown in FIG. 2, each of the welding ribs 3 has a tip (welding portion) 30 and a bonding portion 31. Each of the tip (welding portions) 30 has a front top of the corresponding welding rib 3. Each of bonding portions 31 forms an aft-welding portion of the welding rib 3. The tips 30 of the welding ribs are top parts to be melted in the vibration welding process. The bonding portions 31 of the welding ribs are parts to remain after the vibration welding process, and are to be bonded onto the inner surface of the dashboard 8. In this embodiment, the welding ribs 3 of the air bag door 1 is designed to melt from the top-end with 0.45 mm in the height (i.e. front and back direction in FIG. 1) in the vibration welding process. Therefore, every tip 30 has a length of 0.45 mm in the height from the top-end of the corresponding welding rib 3. Every bonding portion 31 is the remaining bonding portion part of the corresponding welding rib 3.

Every bridging rib 5 has a second tip (second welding portion) 50 and a second bonding portion 51. The second tip 50 is a part of the bridging rib 5 including the top-end thereof. The second bonding portion 51 is a bonding portion part of the bridging rib 5. The second tip 50 is a part to be melted in vibration welding. The second bonding portion 51 is a part to remain after vibration welding, and is a part to be bonded to the inner surface of dashboard 8 with the top plane of the second bonding portion 51.

In this embodiment, each bridging rib 5 is designed to be melted with 0.45 mm from the top-end in vibration welding, similar to each welding rib 3. Therefore, in the embodiment, each second tip 50 is a top part of the corresponding bridging rib 5 with length of 0.45 mm from the top-end in the height direction. Each second bonding portion 51 is a bonding portion part of the corresponding bridging rib 5.

In addition, the welding ribs 3 and bridging ribs 5 in the same combined rib portion 4 are crossing to each other and are unified in the height directions as a whole.

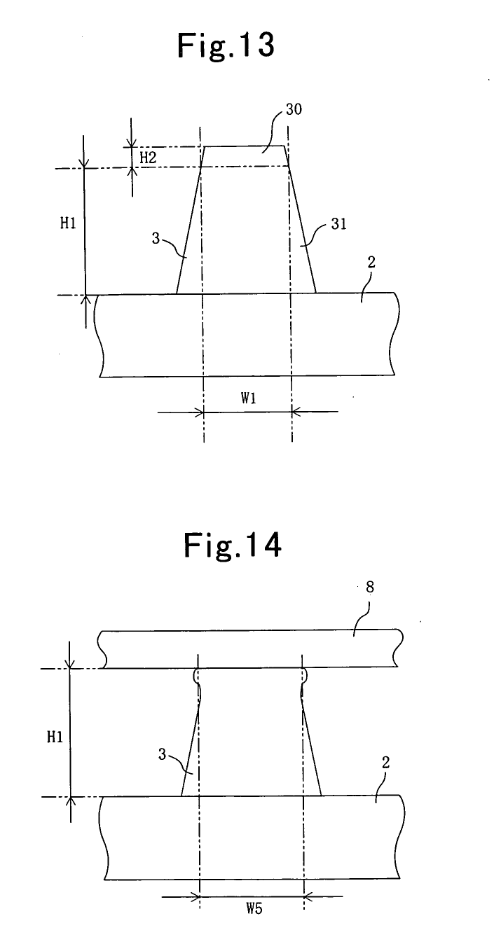

As shown in FIG. 3, each welding width W1 (i.e. the width of the bonding portion as a width of a top-end of each bonding portion 31 as shown in FIG. 13) is 0.6 mm. Each pitch W2 of welding ribs 3 or distance between the neighboring two bonding portions (i.e., the top-ends of neighboring two bonding portions 31 as shown in FIG. 13) is 3 mm. Similarly, each width W3 of each bridging rib 5 (i.e. a width of the second bonding portion of the bridging rib 5, or the width of the top-end section of the second bonding portion 51) is 0.6 mm. Each pitch W4 of the bridging ribs 5 or distance between the neighboring two second bonding portions (i.e., the top-ends of neighboring two second bonding portions 51) is 3 mm.

As shown in FIG. 2, the height H1 of the bonding portion 31 is 2 mm, and the height H2 of the tip 30 is 0.45 mm in each welding rib 3. Similarly, the height H3 of the second bonding portion 51 is 2 mm, and the height H4 of the second tip 50 is 0.45 mm in each bridging rib 5. The width (no reference numeral) of the bottom section of each bonding portion 31 on the surface 25 is 0.7 mm. Similarly, the width (no reference numeral) of the bottom section of each second bonding portion 51 on the surface 25 is 0.7 mm.

In the embodiment, the welding ribs 3 and the bridging ribs 5 are formed on the front surface of the flange 23 at right and left sides. The welding ribs 3 and the bridging ribs 5 formed on the flange 23 have the same shapes of the ribs 3, 5 on the door portions 21. However, the pitches of welding ribs 3 and the pitches of bridging ribs 5 on the flange 23 are longer than these on the door portions 21.

### Second Preferred Embodiment

A structure of the air bag door 1 as a second embodiment of the present invention, i.e. Embodiment 2 is approximately the same as the structure of Embodiment 1, with some exceptions, for example, the arrangement of welding ribs 3 and bridging ribs 5. Perspective view of the air bag door 1 of Embodiment 2 is schematically shown in FIG. 4.

As shown in FIG. 4, the air bag door 1 has welding ribs 3 and bridging ribs 5 formed both on the flange 23 and on the pair of the door portions 21a and 21b. The welding ribs 3 and the bridging ribs 5 on the door portions 21 have the same shape and pitch as the ribs 3, 5 on the flange 23. In other words, the shapes of the welding ribs 3 and the bridging ribs 5 on the flange 23 are the same as the ribs 3, 5 on the door panels 21 of the Embodiment 1.

Each pitch W2 of the welding ribs 3 or distance between the neighboring two bonding portions (i.e., the top-ends of neighboring two bonding portions 31 as shown in FIG. 13) is 3 mm. The definition of the pitch W2 can be referred in FIG. 3 and FIG. 13. Each pitch W4 of the bridging ribs 5 or distance between the neighboring two second bonding portions (i.e., the top-ends of neighboring two second bonding portions 51) is 3 mm.

According to the air bag door 1 of the embodiment, die-drawing operability is improved. The air bag door 1 has tear-line areas 28 on the outer peripherals of the two door portions 21, the inner peripheral and the outer peripheral of the flange 23 as shown in FIG. 4. The ribs 3 and 5 are not provided on the tear-line areas 28. That is, the ribs 3 and 5 are not provided around the outer peripheral brim portions of the door portions 21, inner and outer peripheral brim portions of the flange 23 in order to easily draw dies after die-casting process. Thus, the air bag door 1 as Embodiment 2 can be easily died out.

The tear-line areas 28 in the outer peripheral brim portions of the flange 23 have widths of 3 mm. Similarly, the tear-line areas 28 on upside and downside of inner peripheral portions of the flange 23 have widths of 3 mm. On the other hand, the tear-line areas 28 on the right side and the left side of inner peripheral brim portion of the flange 23 have widths of 9 mm.

The tear-line areas 28 around the door portions have widths of 3 mm.

Every tear-line area 28 of the air bag door 1 is an area to face the corresponding tear-line formed on the dashboard 8 after the vibration welding process.

### Third Preferred Embodiment

A structure of the air bag door 1 as the third preferred embodiment of the present invention, i.e. the Embodiment 3 is approximately the same as the structure of the air bag door 1 as the Embodiment 2 mentioned above, with some exceptions, for example, the arrangement and the shape of welding ribs 3 and bridging ribs 5 formed on the flange 23.

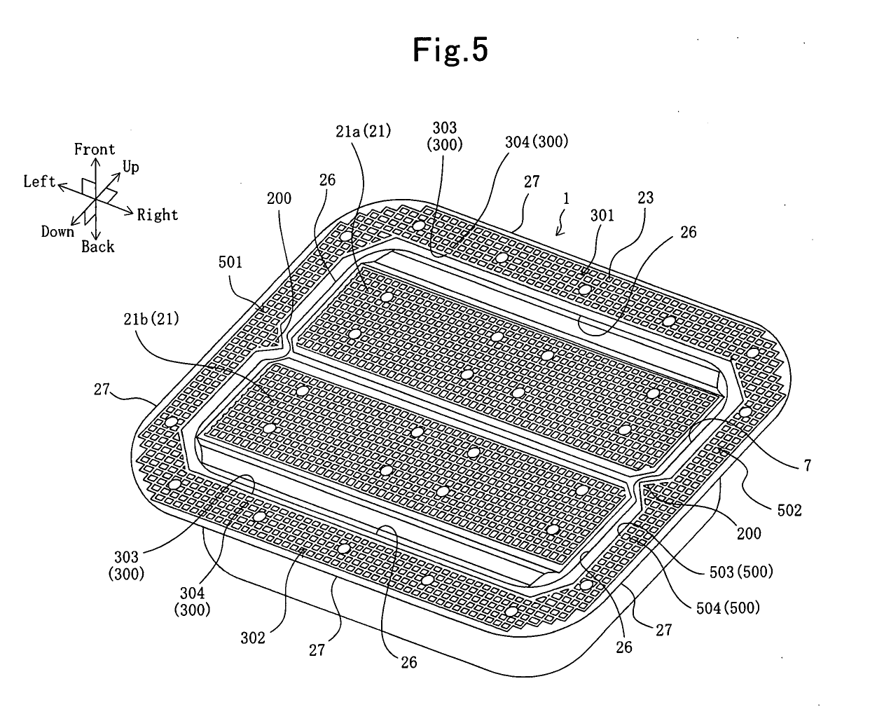

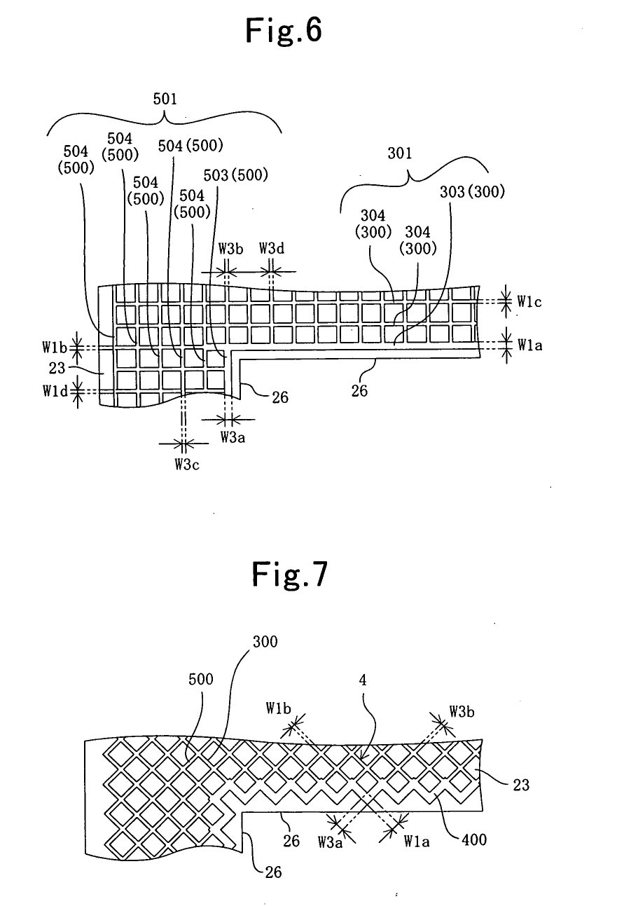

FIG. 5 is a perspective view expressing the structure of the air bag door 1 as the Embodiment 3. FIG. 6 is an enlarged plan view of an essential part of the air bag door 1 seen from the front side.

As shown in FIG. 5, the air bag door 1 has a plurality of welding ribs 3 and a plurality of bridging ribs 5 formed on each welding face of the door portions 21 and the flange 23. The shapes and the pitches of welding ribs 3 and the bridging ribs 5 formed on the door portions 21 are similar to these of the Embodiment 2.

The flange 23 has a rectangular shape, and a rectangular opening 7 is formed in the flange 23. The flange 23 has an inner edge 26 around the opening 7 and an outer edge 27 on the outer side of the flange. The flange 23 has an upper part, a lower part, a left part and a right part with four round corners.

Hereinafter, the welding ribs 3 formed on the flange 23 are called as flange welding ribs 300. Similarly, the bridging ribs 5 formed on the flange 23 are called as flange bridging ribs 500.

As shown in FIG. 6, each flange welding rib 300 is extending in a right and left direction, and each flange bridging rib 500 is extending in a up and down direction.

As shown in FIG. 5, a plurality of flange welding ribs 300 are arranged from the inner edge 26 to the outer edge 27 in an upper part of the flange 23. These flange welding ribs 300 constitute a first line 301 of the welding ribs 300. Similarly, another plurality of flange welding ribs 300 are arranged from the inner edge 26 to the outer edge 27 of the flange in a lower part of the flange 23. These flange welding ribs 300 constitute a second line 302 of welding ribs 300.

As shown in FIG. 6, the first cascade (first line) 301 of the welding ribs 300 include a reinforcement welding ribs 303 arranged nearest to each inner edge 26. Similarly, the second cascade (second line) 302 of welding ribs 300 include a reinforcement welding rib 303 arranged nearest to each inner edge 26. Each reinforcement welding rib in the proximity of the inner edge 26 is wider than the rest 304 of the welding ribs 300 in the cascades 301, 302.

Along the reinforcement welding ribs 303 on the flange 23, each part close to the inner edge 26 has a width W1a of 1 mm in the bonding portion. Other parts of the reinforcement welding ribs 303 have widths W1b of 0.6 mm in the bonding portions. The rest 304 of flange welding ribs 300 have widths W1c of 0.6 mm in the bonding portions. Therefore, the width W1a (1 mm) of the part of the reinforcement welding ribs 303 is wider than the widths W1c (0.6 mm) of the rest 304 of welding ribs 300. In addition, a pitch of the neighboring two flange welding ribs 300 is 3 mm.

Other flange welding ribs 300 are formed on a part of the flange 23 locating on the right and the left of the inner edge 26. These flange welding ribs 300 are arranged between the upper ends and the lower ends of the right and left parts of the flange 23, extending from the inner edge 26 to the outer edge 27 of the flange 23 (see FIG. 5). Each bonding portion of each flange welding rib 300 has a width W1d of 0.6 mm as shown in FIG. 6.

As shown in FIG. 5, a plurality of bridging ribs 500 (including 503 and 504) are arranged from the inner edge 26 to the outer edge 27 on the left part of the flange 23, extending in the up and down direction. These flange bridging ribs 500 constitute a first line 501 of the bridging ribs 500. Similarly, another plurality of flange bridging ribs 500 are arranged from the inner edge 26 to the outer edge 27 on the right part of the flange 23, extending in the up and down direction. These flange bridging ribs 500 constitute a second line 502 of the bridging ribs 500.

As shown in FIG. 6, each of the first line 501 and the second line 502 (see FIG. 5) of the bridging ribs 500 includes reinforcement flange bridging ribs 503 which are the closest to the inner edge 26. The rest 504 of the bridging ribs 500 are included in the first line 501 and the second line 502 of the bridging ribs 500.

Along the reinforcement bridging ribs 503 on the flange 23, each part close to the inner edge 26 has a width W3a of 1 mm in the bonding portion. Other parts of the reinforcement bridging ribs 503 have widths W3b of 0.6 mm in the bonding portions. The rest 504 of flange bridging ribs 500 have widths W3c of 0.6 mm in the bonding portions. Therefore, the width W3a (1 mm) of the part of the reinforcement bridging ribs 503 is wider than the widths W3c (0.6 mm) of the rest 504 of bridging ribs 500. In addition, a pitch of the neighboring two flange bridging ribs 500 is 3 mm.

Other flange bridging ribs 500 are formed on a part of the flange 23 locating on the upside and the downside of the inner edge 26. These flange bridging ribs 500 are arranged between the left ends and the right ends of the upper and lower parts of the flange 23, extending from the inner edge 26 to the outer edge 27 of the flange 23 (see FIG. 5). Each bridging section of each flange welding rib 500 has a width W3d of 0.6 mm as shown in FIG. 6.

In the air bag door 1 of the Embodiment 3, as shown in FIG. 5, the flange welding ribs 300 and the flange bridging ribs 500 are formed on the pair of border parts 200 on the inner edge 26 of the flange 23. The pair of border parts 200 is the parts provided in proximity to the inner edge 26 of the flange 23. Each border part 200 is provided on each end of a border line between the door portions 21a and 21b. Another pair of reinforcement bridging rib 503 is provided on each border part 200, and the two reinforcement bridging ribs 503 are extending in oblique direction to cross each other. A few of the flange welding ribs 300 and other flange bridging ribs 500 are connected to the reinforcement bridging ribs 503 arranged in the upper part and the lower part of the border parts 200. Because the flange welding ribs 300 and the flange bridging ribs 500 including the reinforcement bridging ribs 503 are arranged in the border part 200 in this way, bonding strength between the flange 23 and the dashboard 8 (see FIG. 1) is increased by the border parts 200.

In addition, in the air bag door 1 of the Embodiment 3, each flange welding rib 300 and each flange bridging rib 500 constitute a combined reinforcement rib portion.

### Fourth Preferred Embodiment

FIG. 7 shows an enlarged plan view of an essential part of the air bag door 1 as the fourth preferred embodiment of the present invention, i.e., the Embodiment 4 seen from a front side (see FIG. 1 or 5). Flange welding ribs 300 and flange bridging ribs 500 are crossing to each other, and are extending in the directions oblique to the inner edges 26 of the flange 23.

As shown in FIG. 7, similar to the Embodiment 3, the flange welding ribs 300 and the flange bridging ribs 500 constitute a combined rib portion 4 in Embodiment 4. However, in Embodiment 4, flange welding ribs 300 and the flange bridging ribs 500 are extending in the directions crossing with the inner edge 26 with each inclination of 45 degrees.

In addition, the welding ribs (not shown) formed on door portions 21 (see FIG. 5) are extending in the same direction of the flange welding ribs 300. Similarly, the bridging ribs formed by the door portions 21 are extending in the same direction of the flange bridging ribs 500.

The combined rib portion 4 has a combined rib lattice on the flange 23. The combined rib lattices are made of the crossings of flange welding ribs 300 and flange bridging ribs 500 to form a network of the ribs 300, 500 on the flange 23 and the door portions 21. The combined rib lattice is covering up from the proximity of the inner edge 26 to the proximity of the outer edge 27 on a surface of the flange 23.

The ribs 300, 500 provided on the flange 23 have a combined reinforcement rib portion 400 in a continuous zigzag shape along the inner most parts of the flange 23. Therefore, the combined reinforcement rib portion 400 is surrounding the inner edges 26 of the flange 23. In other words, the combined reinforcement rib portion 400 is provided at the inner most part of the combined rib lattice.

Similar to the reinforcement welding ribs 303 and reinforcement bridging ribs 503 of the Embodiment 3 (see FIG. 6), the combined reinforcement rib portion 400 is wider than the other parts of the combined rib lattice 4 as shown in FIG. 7. The combined reinforcement rib portion 400 has a welding width W1a of 1 mm and a bridging contact width W3a of 1 mm. The welding width W1a is a width of the bonding portion of the flange welding ribs 300, and the bridging contact width W3a is a width of the bonding portion of the flange bridging ribs 500, as shown in FIG. 7.

In other part of the combined rib portion 4, the welding ribs 300 have welding widths W1b of 0.6 mm, as a width of the tip end of the bonding portion of the welding ribs other than the combined reinforcement rib portion 400, and the bridging ribs 500 also have bridging contact widths W3b of 0.6 mm, as a width of the tip end of the bonding portion of the bridging ribs other than the combined reinforcement rib portion 400.

### First Comparative Example

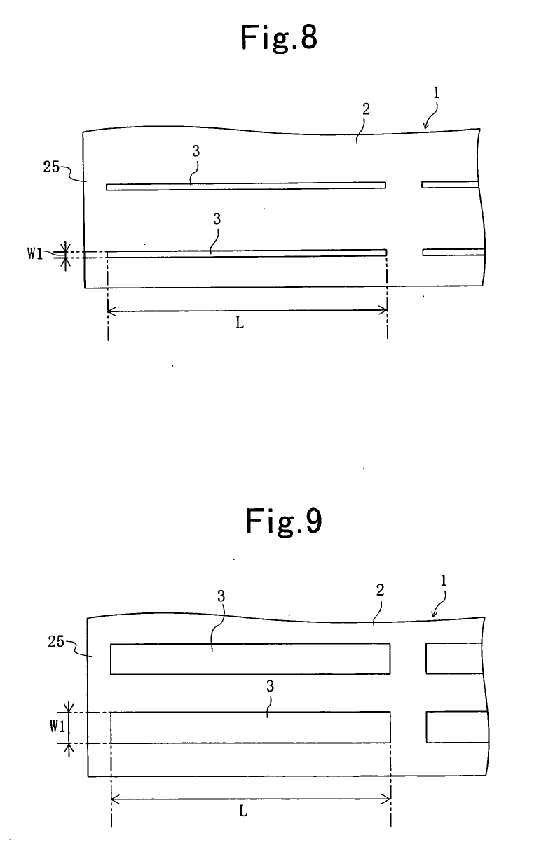

A structure of the air bag door as a Comparative example 1 is similar to the air bag door of the Embodiment 1, except for a shape of welding ribs. FIG. 8 shows an enlarged plan view of an essential part of the air bag door as a Comparative example 1, seen from the front side.

The air bag door 1 as a Comparative example 1 does not have a bridging rib 5 of Embodiment 1, and the bonding portions of welding ribs have welding widths larger than the width W1 (see FIG. 13) of the bonding portion of the Embodiment 1. Therefore, in the Comparative example 1, the neighboring welding ribs 3 are not connected to each other.

Each welding rib 3 of the air bag door 1 of Comparative example 1 has the welding width W1 of 1 mm. Each of the welding ribs 3 formed on the welding face 25 of the door portion 21 has a length L of 45 mm. Each bonding portion 31 (see FIG. 13) has the height H1 of 2 mm, and each tip (welding portion) 30 has the height H2 of 0.45 mm.

### Second Comparative Example

A structure of the air bag door as a Comparative example 2 is similar to the air bag door of the Comparative example 1, except for the shape of the welding ribs. FIG. 9 shows an enlarged plan view of an essential part of the air bag door of Comparative example 2, seen from the dashboard side.

An arrangement and a shape of welding ribs 3 of the Comparative example 2 are approximately similar to these of welding ribs 3 of the Comparative example 1, except for the welding width W1.

In the Comparative example 2, the welding ribs 3 formed on the door portion 21 have the welding width W1 of 5 mm and the length L of 45 mm. Each bonding portion 31 (not shown) has the height H1 of 2 mm, and each tip 30 (not shown) has the height H2 of 0.45 mm.

### Third Comparative Example

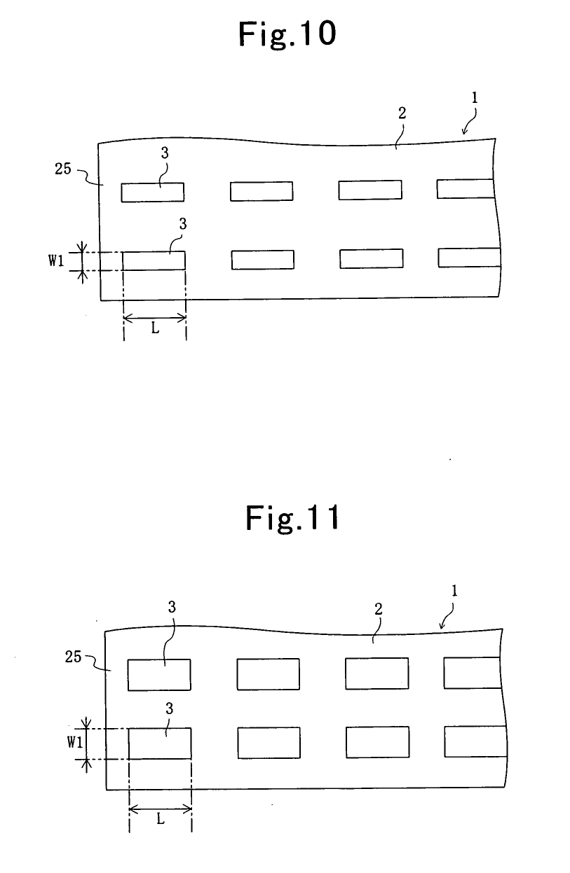

A structure of the air bag door of a Comparative example 3 is similar to the air bag door of the Comparative example 1, except for the shape of the welding ribs. FIG. 10 shows an enlarged plan view of an essential part of the air bag door of the Comparative example 3, seen from the dashboard side.

A shape of the welding ribs 3 in the air bag door 1 of Comparative example 3 is approximately similar to the air bag door 1 of Comparative example 1, except for the welding width W1 and the length L of the welding ribs 3 formed on the door portions 21.

In the Comparative example 3, the welding ribs 3 formed on the door portion 21 have the length L of 10 mm and have the welding width W1 of 3 mm. Each bonding portion 31 (not shown) has the height H1 of 2 mm, and each tip 30 (not shown) has the height H2 (not shown) of 0.45 mm.

### Fourth Comparative Example

A structure of the air bag door of a Comparative example 4 is approximately similar to the air bag door of the Comparative example 1, except for the shape of the welding ribs. FIG. 11 shows an enlarged plan view of an essential part of the air bag door of Comparative example 4, seen from the dashboard side.

A shape of the welding ribs 3 in the air bag door 1 of the Comparative example 4 is approximately similar to the air bag door 1 of the Comparative example 1, except for the welding width W1 and the length L of the welding ribs 3 formed on the door portion 21.

In the Comparative example 4, the welding ribs 3 formed on the door portion 21 have the length L of 10 mm and the welding width W1 of 5 mm. Each bonding portion 31 (not shown) has the height H1 of 2 mm, and each tip 30 (not shown) has the height H2 of 0.45 mm.

[Test Pieces for Evaluation Tests]

Some test pieces were made by cutting the door portions 21 in the shape of predetermined form. The test pieces were corresponding to the door portions 21 of the air bag doors 1 of Embodiments 1-3 and Comparative examples 1-4. Test pieces of the dashboard 8 were made from PP (polypropylene) resin materials. The test pieces of the dashboard 8 were slightly larger than the test pieces of the air bag door 1.

One test piece of the air bag door 1 was made from each air bag door of Embodiments 1-3 and Comparative examples 1, and 3-4. Two test pieces were made from the air bag door 1 of the Comparative example 2. Seven test pieces were made from the dashboard 8. Among these test pieces, five test pieces have the board thickness of 1.5 mm, one test piece has the board thickness of 2.5 mm and the last test piece has the board thickness of 2.0 mm.

By vibration welding, each test piece of the air bag door was welded onto each test piece of the dashboard 8. Thus, welded test pieces as specimen. Nos. 1-8 were made as follows.

For an examination, a pair of first through holes 510 were formed in the test piece of each air bag door 1. Another pair of the second through holes 520 were formed in each test piece of the dashboard 8, where the second trough holes 520 were positioned to meet the first through holes 510. Each second through hole 520 had a diameter larger than that of each first through hole 510.

As mentioned above, welded test pieces 9 as specimen Nos. 1-6 were made. The test piece of each air bag door 1 as Embodiments 1-3 and Comparative examples 1, 3, 4 were welded to the test piece of the dashboard 8 having the board thickness of 1.5 mm by vibration welding. In this vibration welding process, the amplitude of the vibration was 3 mm, and the frequency of the vibration was 101.8 Hz. A duration time of vibration was set adequately so that the welding ribs 3 of the corresponding test piece of each air bag door 1 would be melted by 0.45 mm in the height direction. In addition, the vibration amplitude of the vibration welding, the frequency, and the duration time are similarly set in the welded test pieces, i.e., the specimen Nos. 7-8 mentioned later.

One of the two test pieces of the air bag door 1 as the Comparative example 2 was welded by vibration welding onto the test piece of the dashboard 8 with the board thickness of 2.5 mm to make the specimen No. 7. The other of the test piece of the air bag door 1 as the Comparative example 2 was welded by vibration welding onto the test piece of the dashboard 8 of board thickness 2.0 mm to make the specimen No. 8.

[Measurement of Tip End of Bonding Portion (as Percentage)]

The grand total of the area of the tip end of the bonding portion 31 in the test piece of each air bag door 1 was calculated. After that, in an area (100%) of the whole welding face 25 in the test piece of each air bag door 1, the ratio (percentage) of the area of the tip end to the area of the welding face 25 was calculated.

The percentage of the tip end in the test piece of each air bag door 1 are listed in table 1.

[Evaluation on Appearance of Dashboard]

The visual inspection was made on the surface of the dashboard 8 of each of the specimen Nos. 1-8 to evaluate the visual appearance.

In case where the irregularity found on the surface of the dashboard 8 was under 2 μm, the specimen was evaluated as superior class S in visual appearance. Similarly, when the irregularity was 2 μm or more and under 5 μm, the specimen was evaluated as good class A. When the irregularity was 5 μm or more and under 10 μm, the specimen was evaluated as a little inferior class B. Finally, when the irregularity was 10 μm or more, the specimen was evaluated as inferior class C.

Thus, the evaluated visual appearances of the specimens Nos. 1-8 as a result are listed in table 1.

[Measurement Test on Peeling Strength]

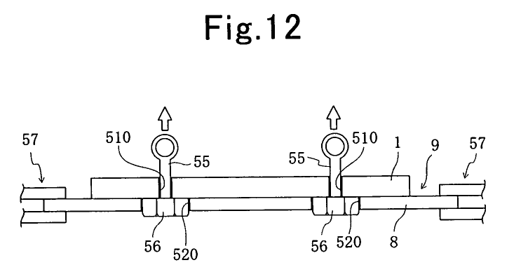

As shown in FIG. 12, in a welded test piece 9 as specimen Nos. 1, 2, 4 and 8, an eyebolt 55 was inserted in each first through hole 510 and each second through hole 520. A nut 56 was fitted in each second through hole 520 to tighten the tip of the eyebolt 55. Each nut 56 was fitted in each second through hole 520, and contacts tightly with the air bag door 1 around the first trough hole 510 thereof. Both the edges of each welded test piece 9 as specimen Nos. 1, 2, 4 and 8 was fixed in a pair of fixtures 57, and the eyebolts 55 were connected to a draw gear (not shown). In the state that the welded test piece 9 is set as mentioned above, the draw gear was pulled in the direction apart from a welded test piece 9. The eyebolt 55 was pulled in this way and the tensile load increased slowly, until the test piece of the air bag door 1 was torn off the test piece of the dashboard 8. Tensile load added to an eyebolt 55 was recorded when the test piece of the air bag door 1 came off the test piece of the dashboard 8.

As a result, when recorded load was less than 294 N, the specimen was evaluated as Class (X) inferior to peeling strength. Similarly, when the load was 294 N or more and under 1000 N, the specimen was evaluated as Class (∘) superior in peeling strength. Finally, when the load was 1000 N or more, the specimen was evaluated as Class (⊚) especially superior in peeling strength.

Thus, the classes of peeling strength of the specimen Nos. 1, 2, 4 and 8 are listed in table 1.

[Evaluation Test on Resistance to Peeling-Off]

Each air bag door 1 as above-mentioned Embodiment 2 and Embodiment 3 was attached to each dashboard 8 by vibration welding. Thereafter, an air bag unit was installed in each air bag door 1, and the air bag was inflated. After the air bag inflated, the visual inspection was carried out to check if the dashboard 8 is peeled off the air bag door 1 or not.

As a result, when peeling-off was not found, the specimen was evaluated as class (∘) superior in peel resistance. When no fragment of the dashboard breaks up, even though the peeling-off and the breaking of the dashboard were found, the specimen was evaluated as class (Δ) inferior in peeling-off resistance a little. When peeling-off and breaking of the dashboard were found, and fragments of the dashboard are scattered, the specimen was evaluated as class (X) inferior in peeling-off resistance.

Thus, the peeling-off resistance of the air bag doors 1 as Embodiment 2 and Embodiment 3 are listed in table 1.

TABLE 1

| | | Specimen No. | | | | | | | |
|---|---|---|---|---|---|---|---|---|---|
| | | 1 | 2 | 3 | 4 | 5 | 6 | 7 | 8 |
| Air bag door | | Embod- | Embod- | Embod- | Comparative | Comparative | Comparative | Comparative | Comparative |
| | | iment 1 | iment 2 | iment 3 | 1 | 3 | 4 | 2 | 2 |
| (Other) | Welding | 0.6 | 0.6 | 0.6 | 1 | 3 | 5 | 5 | 5 |
| welding ribs | width W1 | | | | | | | | |
| Dimensions | Length L | — | — | — | 45 | 10 | 10 | 45 | 45 |
| [mm] | Pitch W2 | 3 | 3 | 3 | — | — | — | — | — |
| | Height H1 | 2 | 2 | 2 | 2 | 2 | 2 | 2 | 2 |
| With | | No | No | Yes | No | No | No | No | No |
| Reinforcement welding ribs | | | | | | | | | |
| With | | No | No | Yes | No | No | No | No | No |
| Reinforcement bridging ribs | | | | | | | | | |
| (Other) | Bridging | 0.6 | 0.6 | 0.6 | — | — | — | — | — |
| bridging ribs | contact | | | | | | | | |
| Dimensions | width | | | | | | | | |
| [mm] | W3 | | | | | | | | |
| | Pitch W4 | 3 | 3 | 3 | | | | | |
| | Height H3 | 2 | 2 | 2 | | | | | |

| | | | | | | | | |
|---|---|---|---|---|---|---|---|---|
| Percentage of welding face | 37 | 37 | — | 6 | 13 | 22 | 32 | 32 |
| [%] | | | | | | | | |
| Thickness of Dashboard | 1.5 | 1.5 | — | 1.5 | 1.5 | 1.5 | 2.5 | 2 |
| [mm] | | | | | | | | |
| Peeling strength | ⊚ | ⊚ | — | ◯ | — | — | — | ⊚ |
| Visual appearance of | S | S | S | A | B | C | S | C |
| Dashboard | | | | | | | | |
| Resistance to Peeling-off | — | Δ | ◯ | — | — | — | — | — |

A test piece of the air bag door 1 is described merely the air bag door 1 in the followings. Similarly, a test piece of the dashboard 8 is described merely the dashboard 8.

As listed in the table 1, whereas the specimen No. 7 was superior in the visual appearance, the specimen No. 8 was inferior in the visual appearance. The dashboard 8 of the specimen No. 7 had the board thickness of 2.5 mm, but the dashboard 8 of the specimen No. 8 had the board thickness of 2.0 mm. In other words, when the air bag door 1 having the welding width W1 of 5 mm or more were welded by vibration welding to the dashboard 8 having the board thickness of 2.0 mm or less, the visual appearance of the dashboard 8 turns worse.

The specimen No. 6 was inferior in the visual appearance, where the specimen was the combination of the air bag door 1 having welding width W1 of 5 mm, and the dashboard 8 having the board thickness of 1.5 mm. In contrast, the specimen No. 5 was superior in the visual appearance, where the specimen was the combination of the air bag door 1 with the welding width W1 of 3 mm and the dashboard 8 with the board thickness of 1.5 mm. This result shows that the visual appearance of the dashboard 8 did not turn worse because the welding width W1 was set to be 3 mm or less, even though the air bag door 1 is welded by vibration welding onto the dashboard 8 having the board thickness of 2.0 mm or less. In other words, the air bag door 1 of the present invention could be attached by vibration welding onto the dashboard 8 having the board thickness of 2.0 mm or less, while keeping the good visual appearance of the dashboard 8.

The specimen No. 4 was superior in the visual appearance, where the specimen was the combination of the air bag door 1 having welding width W1 of 1 mm and the dashboard 8 having the board thickness of 1.5 mm. That is, the above specimen No. 4 has the superior visual appearance in comparison with that of the specimen No. 5 as the combination of the air bag door 1 having welding width W1 of 3 mm and the dashboard 8 having the board thickness of 1.5 mm. The result tells that when welding width W1 is set 1 mm or less, the visual appearance of the dashboard 8 can be kept better even though the air bag door 1 is welded by vibration welding onto the dashboard 8 having the board thickness equal to or less than 2.0 mm.

Furthermore, the visual appearance was still superior on the specimens Nos. 1-3 as the combination of the air bag door 1 having welding width W1 of 0.6 mm and the dashboard 8 having the board thickness of 1.5 mm, in comparison with the specimen No. 4 as the combination of the air bag door 1 having welding width W1 of 1 mm and the dashboard 8 having the board thickness of 1.5 mm.

As a result, the best visual appearance of the dashboard 8 could be obtained when the welding width W1 was set 0.6 mm or less, even if the air bag door 1 was welded onto the dashboard 8 having the board thickness of 2.0 mm or less by vibration welding.

In addition, a preferred range of the welding width W1 is in the range of 0.5-1 mm. Similarly, it is preferable that the bridging contact width is in the range of 0.5-1 mm.

In addition, the specimens Nos. 1 and 2 were superior in the resistance to peeling-off, just like the specimen 8. The reason is thought as follows. The specimens Nos. 1-2 had the bridging ribs 5 as well as the welding ribs 3, so that percentage of the tip end of the bonding portion and the second tip end of the second bonding portion can be secured enough, even if each welding width W1 and each bridging contact width W3 were narrow. Considering this result, the air bag door 1 of this invention can be welded onto the dashboard 8 with high resistance to peeling-off.

The width of the welding ribs 3 should be set properly depending on the melting height of the welding ribs 3 in the vibration welding as described in the followings for example. As shown in FIG. 13, when the welding ribs 3 are to be formed in the tapering shape, the ribs should be designed as follows. At first, a position of the tip end of the bonding portion 31 is set depending on the molten height of the welding ribs 3 set beforehand. Next, the shape of the welding ribs 3 is decided so that the width (i.e. welding width W1) of the tip end of this bonding portion should be 3 mm or less. It is preferable for the width W1 of the bonding portion to be equal to or less than 1 mm. More preferably, the width should be equal to or less than 0.6 mm.

In addition, the top portion of the welding rib 3 will melt in welding and flow outside. As shown in FIG. 14, the actual width W5 of welding of the welding rib 3 attached to the dashboard 8 becomes wider than the width W1 of the bonding portion before vibration welding. The rib 3 is attached or welded to the dashboard 8 with the actual width W5 at the bonding portion is preferable to be 3 mm or less. The actual width W5 of welding is more preferably set to be 1 mm or less, and is most preferable to be set to be 0.6 mm or less.

That is similar in about the second welding width W3 of the bridging rib(s) 5. In addition, in the air bag door 1 of this invention, the bridging contact width W3 is not limited in particular. Because the bridging rib(s) 5 are arranged in crossing direction to the direction of vibrating motion of the vibration welding, so that the bridging rib(s) 5 are difficult to be welded in comparison with the welding ribs 3. Therefore, the bridging rib(s) 5 do not cause a large thermal shrinkage just after vibration welding. Similarly, even in the dashboard 8, the part that each bridging rib(s) 5 are attached is difficult to cause a large thermal shrinkage after vibration welding. As a result, the bridging rib(s) 5 is difficult to affect in the visual appearance of the dashboard 8. Therefore, the bridging contact width W3 may exceed 3 mm and may be 3 mm or less. When the bridging contact widths W3 are 3 mm or less, the visual appearance of the dashboard 8 would not turn worse. Furthermore, when the air bag door 1 of this invention has a plurality of bridging ribs 5, each bridging rib 5 may extend in a direction parallel to each other, and may extend in crossing directions to each other.

In the air bag door 1 of the invention, the top surface of tip 30 and the top surface of second tip 50 may be formed in flat shape, round shape or sharp-pointed shape before the vibration welding. As the width of each tip 30 or second tip 50 is set to be smaller, the friction resistance in the vibration welding would be lighter.

Furthermore, in the air bag door 1 as Embodiment 1 and 2, the pitch of the tip end of the bonding portions 31 is 3 mm, as well as the pitch of the tip end of the second bonding portions 51. As the percentage of the tip end area is relatively large in the air bag door 1 of Embodiment 1 and 2, superior peeling strength can be obtained. The peeling strength of the air bag door 1 can be improved by setting both pitches of the tip end of the bonding portion 31 and the tip end of the second bonding portion 51 to be 3 mm. It is preferable that the pitches of the tip end of the bonding portion 31 and the tip end of the second bonding portion 51 are in the range of 2-5 mm.

In addition, as listed in the table 1, the resistance to peeling-off is inferior in the air bag door 1 as Embodiment 2, compared with that in Embodiment 3. That is the reason why the air bag door of Embodiment 3 has reinforcement welding ribs 303 and reinforcement bridging ribs 503 as shown in FIG. 6. On the contrary, the air bag door 1 of Embodiment 2 does not have the reinforcement ribs 303, 503. As a result, the part near the tear-lines (not shown) of the dashboard 8 can be reinforced by reinforcement welding ribs 303 and reinforcement bridging ribs 503 of the air bag door 1. Hereby, the peeling-off of the dashboard 8 can be avoided at the air bag inflation.

The reinforcement welding ribs should have the welding width wider than that of the other welding ribs in the range of width W1 of 3 mm or less in the bonding portion. Similarly, the reinforcement bridging ribs should have the second bonding portions the width of which is wider than that of the other bridging ribs in the range of 3 mm or less. However, to keep the good visual appearance of the dashboard, the welding width of the reinforcement welding ribs and the bridging contact width of the reinforcement bridging ribs are preferably set to be 1 mm or less. When tolerance is considered here, the welding widths and the bridging contact width should be equal to 1.15 mm or less. More particularly, the welding width of the reinforcement welding ribs and the bridging contact width of the reinforcement bridging ribs are preferably in the ranges from 0.8 mm to 1.15 mm. In this case, the welding width of the welding ribs other than reinforcement welding rib(s) and the welding contact width of the bridging rib(s) other than the reinforcement bridging rib(s) are preferably set to be 0.6 mm or less. Considering the tolerance, the welding width of the welding ribs other than reinforcement welding rib(s) and the welding contact width of the bridging rib(s) other than the reinforcement bridging rib(s) are preferably in the range of 0.3-0.75 mm.

Mentioning on the reinforcement welding rib(s), the reinforcement bridging rib(s), the other welding rib(s) and the other bridging rib(s), it is preferable for the mentioned ribs to have uniform widths. However, these ribs are not necessarily to set to have uniform widths. In this case, the widest welding width and/or the bridging contact width is preferably in the range mentioned above. Similarly, the narrowest welding width and/or the bridging contact width is preferably in the range mentioned above.

The bridging rib(s) connecting with the reinforcement welding rib(s) may be extended to the inner edge over the reinforcement welding rib(s). The part(s) in the bridging rib(s) which are extended to the inner edge over the reinforcement welding rib may be formed to be wide similar to the reinforcement welding rib(s). In this aspect, welding strength can be farther improved between the inner peripheral edge of the flange of the air bag door 1 and the dashboard 8. Furthermore, in this case, not all the bridging rib is necessarily made wide, but only by making any of the bridging rib(s) wide partially, the worsening of the visual appearance of the dashboard 8 by the vibration welding can be prevented. Similarly, the welding rib(s) connecting with the reinforcement bridging rib(s) may be extended out to the inner edge over the reinforcement bridging rib(s). Parts of the welding rib(s) extended out to the inner edge over the reinforcement bridging rib(s) may be formed as wide as the reinforcement bridging rib(s).

When at least one of the welding rib(s) and bridging rib(s) is formed on the flange, the extending direction of these rib(s) is not limited in particular. For example, the extending direction of these ribs is not necessarily to be along the inner edges 26, or these ribs may extend in parallel with a part of the inner edge.

Furthermore, similarly to the air bag door of Embodiment 3, by the air bag door of Embodiment 4, the unexpected peeling-off of the dashboard at the air bag inflation can be prevented, and the worsening of the visual appearance of the dashboard by the vibration welding can be effectively prevented.

That is because the air bag door 1 of Embodiment 4 has combined reinforcement rib portion. The combined reinforcement rib portion is placed near the inner edge of the flange, and are continuously extended around the inner edge. On this account, the combined reinforcement rib portion is securely welded onto the dashboard, as well as the reinforcement welding ribs and the reinforcement bridging rib(s). The combined reinforcement rib portion can endure against the shearing stress and the pulling stress acting on the welded part in the dashboard welded on the flange. Therefore, similarly in this case, the peeling-off of the dashboard from a retainer can be restrained at air bag inflation.

The widths of the ribs in whole the combined rib portion is not necessarily set to be wide. The worsening of the visual appearance of the dashboard by the vibration welding can be prevented by forming some parts of the combined rib portion wide.

[Operation of the Aspect of the Invention]

As described in the article titled as Aspect of the Invention, the operation and effects are provides as followings.

The air bag door of this aspect has the plurality of welding ribs. Each of the welding ribs has a welding portion to be melted in vibration welding, and a bonding portion to remain after the ribs are welded to the dashboard by vibration welding. The bonding portions are parts to be welded to the inner surface of the dashboard at the tip end. The tip end of the bonding portion is limited narrowly, of which the width is equal to or less than 3 mm.

Hereby, the good visual appearance of the dashboard can be kept after vibration welding. Reducing the width of the tip end of the bonding portions reduces the area that the welding ribs and the dashboard are bonded each other in vibration welding.

At the same time, the bonded area per unit area of the welding face can be reduced, too. Therefore, the heat per the unit area, which is generated during vibration welding on the bonded area between the air bag door and the dashboard, can be reduced in vibration welding on the attachment area. Furthermore, while they are cooled down after vibration welding, the shrinkage difference can be minimized between the dashboard and the welding ribs. As a result, unevenness hardly occurs on the dashboard surface, even though that is apt to occur after vibration welding by thermal contraction. Therefore, the air bag door as this aspect has an effect that the good visual appearance of the dashboard can be kept, even though it is bonded by vibration welding to the thin dashboard with board thickness equal to or less than 2.0 mm.

By the way, only by making welding width small as mentioned above, the welding ribs become so narrow that they may easily be bent or inclined in vibration welding. If welding ribs would be inclined, the dashboard is deformed with deformation of the welding ribs, thus the good visual appearance of the dashboard may be damaged. In addition, bond strength by the welding with the air bag door and the dashboard may deteriorate. On the other hand, unlike this aspect, the welding ribs may be prevented from their incline if the welding condition is arranged with jigs or something to prevent welding rib from incline. However, in that way, jigs must be prepared beforehand, and processes such as the mounting or dismounting of the jigs occur in vibration welding. As a result, equipment investment would increase, and process of the vibration welding would become complicated. Therefore, the air bag door as this aspect has the bridging rib(s) extending across the welding ribs to overcome such inconveniences. Then, the plurality of welding ribs is connected to each other by the bridging rib(s), and the welding ribs are supported by the bridging rib(s) not to incline. Thus, the welding ribs are narrow but are hard to incline because these are supported by the bridging rib(s). In other words, according to this aspect, the welding ribs is difficult to incline by support of the bridging rib(s) even though the welding widths of the welding ribs are set to be small. As a result, in the air bag door as this aspect, the good visual appearance of the dashboard will be kept after vibration welding. According to this aspect, even though the dashboard is lightened by the thin board thickness equal to or less than 2 mm.

In addition, the visual appearance of the dashboard is hardly spoiled by the vibration welding of the air bag door, and large detachment is hard to occur at the air bag inflation.

Generally, when the air bag door has welding ribs only, the rigidity and the strength of the air bag door are great along the direction where welding ribs are extending, but are not so great in the direction across the welding ribs. However, as well as the above-mentioned welding ribs, the air bag door of this aspect has bridging rib(s) extending across the welding ribs. Therefore, the air bag door of this aspect has improved rigidity and strength along the direction across the welding ribs.

Therefore, according to this aspect, the welded part between the air bag door and the dashboard is hard to be damaged and separation hardly happens, even when great load is given at the deployment of the air bag.

The invention may have further additional aspects as described below. In the followings, the constitution of each aspect for solving the problem is to be explained in two groups of the aspects. The operations and effects of each aspect will be explained together.

According to one aspect of the embodiment of the invention, the air bag door includes a width of the tip end of the bonding portion of the welding rib being equal to or less than 1 mm

According to still another aspect of the embodiment of the invention, the width of the tip end of the bonding portion of the welding rib is equal to or less than 0.6 mm.

In both aspects mentioned above, the good visual appearance of the dashboard can be kept more surely by making the welding width smaller and smaller. Of course, the visual appearance of the dashboard is kept better because the heat is small where the welding width is narrower. On the other hand, the bond strength must be kept, too. Therefore, the degree of the welding width of both aspects would be appropriate.

According to a fourth aspect of the embodiment of the invention, the bridging rib has a second welding portion to be melted at the time of vibration welding and a second bonding portion to be bonded to the inner surface of the dashboard, remaining at the time of vibration welding, wherein a width of a tip end of the second bonding portion is equal to or less than 3 mm.

In this aspect, width limitation is set to be small on the top width (that is bridging contact width) of the second bonding portion. Therefore, the visual appearance of the dashboard is hardly spoiled by the bridging ribs.

Therefore, according to this aspect, the visual appearance of the dashboard is kept better.

According to a fifth aspect of the embodiment of the invention, the bridging rib includes a plural number of bridging ribs and the mutually neighboring welding ribs and mutually neighboring bridging ribs are formed integrally to form a combined rib portion in a shape of a grid.

The deformation of the welding ribs and the bridging ribs in the combined rib portion is prevented. According to this aspect, the air bag door and the dashboard are more strongly joined to surely prevent peeling-off, while the good visual appearance of the dashboard is kept.

According to a sixth aspect of the embodiment of the invention, the bridging rib is arranged perpendicular to a vibrating direction of the vibration welding.

In this aspect, the welding ribs and the bridging ribs are crossing perpendicular to each other. Therefore, the welding ribs are supported most impregnably by the bridging ribs, or vice versa. As a result, deformation of welding ribs and bridging ribs can be suppressed in vibration welding.

Therefore, according to this aspect, the visual appearance of the dashboard is kept better. Furthermore, peeling-off hardly happens at the air bag inflation, because the dashboard and the air bag door are welded stronger.

According to a seventh aspect of the embodiment of the invention, wherein the main portion has a retainer portion having a cylindrical retainer main portion and a frame shaped flange portion integrally formed with the retainer main portion at a dashboard side end thereof, and a door portion swingably connected to the retainer portion and wherein the welding face and the plurality of welding ribs and the bridging ribs are formed at the flange portion and the door portion.

In this aspect, the welding ribs and the bridging ribs are arranged on the welding face of the main portion. The air bag door comprises the flange and the door portions, where the welding face is welded to the inner surface of the dashboard.

Therefore, the main portion of the air bag door is welded strongly on the inner surface of the dashboard. Thus, the dashboard and the air bag doors are strongly welded to each other. Then, deformation and damage of the dashboard can be prevented.

Therefore, according to this aspect, a part of the thin-walled dashboard can be reinforced by the air bag door, so that deformation and breakage of the dashboard can be restrained.

[Second Group of Additional Aspects]

By the way, in these years it is demanded that almost all kinds of interior parts must be made lighter than before for vehicle light weighting. Of course it would be good for light weighting if the dashboard were made thinner. However, the uneven surface of the dashboard would be more uneven as mentioned above. Thus, vibration welding would spoil the visual appearance of the thinner dashboard. The design characteristics of the dashboard turned worse remarkably when the thickness of the dashboard was thinned to around 2.0 mm, for example. By the way, as mentioned above, at the time an air bag inflates, the main portion of the air bag door transforms to let the air bag inflate into the passenger compartment. Dashboard breaks with the opening deformation of the main portion of the air bag door when the door portions are open. Therefore, a breaking line (so-called “tear-lines”) is formed beforehand not to disturb the expansion of the air bag in dashboard.

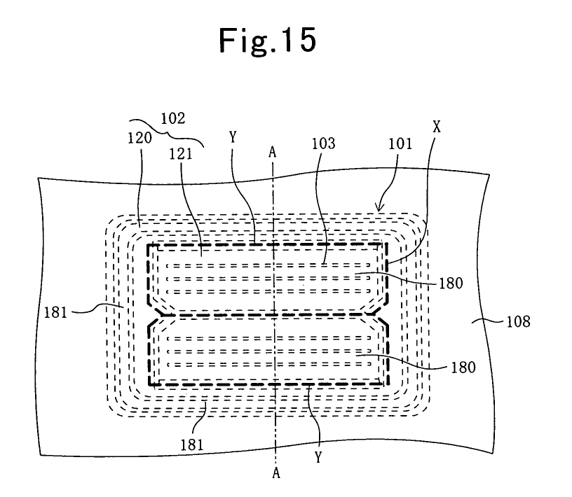

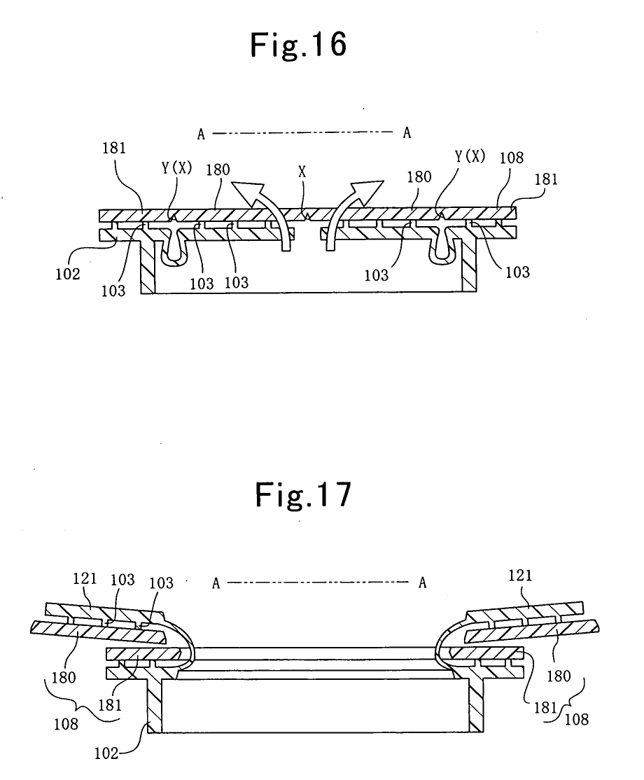

In the following, FIGS. 15-17 are referred to concretely explain the general behavior of the dashboard and the air bag door at the time of the air bag development. FIG. 15 is a front view showing a usual dashboard and the air bag door from the dashboard side. FIG. 16 and FIG. 17 are cross section views of the air bag door at a cut line A-A in FIG. 15 to show before and after the deployment of the air bag. As shown in FIG. 15, before the development of the air bag, the breaking line X is formed by shape corresponding to the external form of the door portions 121. Here, a main portion 102 of the air bag door 101 has retainer 120 and the door portions 121.

As shown in FIG. 16, welding ribs 103 is not formed on a part meeting break line X of the dashboard in the main portion 102 of the air bag door 101, so that the ribs would not disturb a break of dashboard 108. Therefore, when the air bag expands as shown in FIG. 17, the main portion 102 of the air bag door 101 transforms to open the door portions 121. Then the parts of dashboard 108 corresponding to the door portions also open. Among the welded part 180 of the dashboard 108, a part welded to the door portions 121 are displaced with the door portions 121. On the other hand, other parts of the dashboard 108 welded to a flange of the retainer 120 are not displaced. As a result, the above-mentioned parts of the dashboard of the door portions 121 are torn apart from the main portion of the dashboard 108. At this time, tearing force is applied to the breaking line Y (shown in FIG. 15 and FIG. 16) is located nearby the hinge lines of the door portions 121 to be torn. On this occasion, the edges of the fixed welded part 181 located nearby the breaking line Y are pulled by the door portions 121.

Therefore, if this pulling force or tension is too large, the welded part 181 may come off the retainer 120 at the time of air bag inflation. If the welded part 181 is peeled off, the dashboard 108 would be damaged.

To restrain this separation, welding ribs should be made wide, and that was the way of the prior art. By making welding ribs wide, a bonded area with welding ribs and the dashboard becomes large. Thus, the bond strength with welding ribs and the dashboard is strengthened, so that the detachment is prevented. However, if all welding ribs are made wide, the welding width is made large as mentioned above. As a result, in case the dashboard is not thick enough, the visual appearance of the dashboard would be lost greatly. In other words, by conventional technology, if it is made that large scaled detachment would not occur at the inflation of the air bag, the dashboard must be thickens. As a result, the weight increases to keep the good visual appearance of the dashboard. On the contrary, if the dashboard is lightened by thinning the board thickness thereof, the visual appearance of the dashboard is lost, and large peeling-off occurs at the inflation of the air bag. When the board thickness of the dashboard is equal to or less than 2 mm in particular, vibration welding causes some deformations on the dashboard surface. The deformations are large enough to be seen from users, which result in the good visual appearance can not be kept any more.

The following second group of aspects is provided to overcome the problem.

According to an aspect of the second group of the embodiment of the invention, wherein the main portion has a retainer portion having a cylindrical retainer main portion and a frame shaped flange portion integrally formed with the retainer main portion at a dashboard side end thereof and a door portion swingably connected to the retainer portion, the welding face is formed at the flange portion and the door portion, the flange portion is provided with a line of welding ribs arranged from one end of an inner periphery of the flange portion to one end of an outer periphery of the flange portion, the line of the welding ribs includes a reinforcement welding rib arranged closest to the one end of the inner periphery of the flange, and wherein a portion of the tip end of the bonding portion of the reinforcement welding rib has a width wider than any other tip end of the bonding portion of the line of welding ribs.

In this aspect the welding ribs formed on the flange are classified into two types, where the first type is arranged nearby a breaking line and is used for reinforcement, and the second type is arranged apart from the breaking line and is used for welding. Among these two types of welding ribs, the welding width of the reinforcement welding rib(s) are set more widely than the welding width of the second type welding rib(s) (hereinafter, referred to as standard welding rib).

Therefore, some parts in welding face are welded strongly by reinforcement welding rib, where strong shearing force acts on the parts in particular. As a result, the dashboard would not be peeled off from the retainer even at the inflation of the air bag. In addition, the visual appearance of the dashboard would not be spoiled by vibration welding, because the width of the standard welding rib(s) is narrower than the width of the reinforcement welding rib(s).

Therefore, according to this aspect, the visual appearance of the dashboard can be kept well, though peeling-off with the retainer and the dashboard is prevented even at the inflation of the air bag.

According to a ninth aspect of the invention, the main portion has a retainer portion having a cylindrical retainer main portion and a frame shaped flange portion integrally formed with the retainer main portion at a dashboard side end thereof and a door portion swingably connected to the retainer portion, the welding face is formed at the flange portion and the door portion, the flange portion is provided with a line of bridging ribs arranged from one end of an inner periphery of the flange portion to one end of an outer periphery of the flange portion, the line of the bridging ribs includes a reinforcement bridging rib portion arranged closest to the one end of the inner periphery of the flange, and wherein a portion of the tip end of the second bonding portion of the reinforcement bridging rib has a width wider than any other tip end of the second bonding portion of the line of bridging ribs.

This aspect has the welding ribs and the bridging ribs. In addition, the bridging ribs are forming at least in a line arranged on the flange. One of the bridging ribs forming a line is the reinforcement bridging rib. The bridging contact width of the reinforcement bridging rib is wider than the bridging contact width of the bridging rib(s) other than the reinforcement bridging rib (hereinafter referred to as standard bridging rib(s)). As a result, the dashboard and the air bag door are welded so strongly, that deformation and damage of the dashboard can be prevented with higher dependability.

Therefore, according to this aspect, the visual appearance of the dashboard can be kept well, though peeling-off with the retainer and the dashboard is prevented even at the inflation of the air bag.

According to a tenth aspect of the invention, wherein the width of the portion of the tip end of the bonding portion of the reinforcement welding rib is equal to or less than 1 mm, whereas the width of the tip end of the bonding portion other than the reinforcement welding rib is equal to or less than 0.6 mm.

In this aspect, the welding width is limited narrowly on the standard welding rib(s). On the other hand, the welding width of the reinforcement bridging rib(s) is limited slightly widely.

Therefore, according to this aspect, the peeling-off of the dashboard from the air bag door can be restrained more surely, while keeping the good visual appearance of the dashboard.

According to an eleventh aspect on the embodiment of the invention wherein the width of the tip end of the second bonding portion of the bridging rib is equal to or less than 1 mm

In this aspect, the good visual appearance of the dashboard can be kept more surely because the bridging contact width is limited more narrowly.

According to a twelfth aspect of the embodiment of the invention, wherein the width of the portion of the tip end of the second bonding portion of the reinforcement bridging rib is equal to or less than 1 mm, whereas the width of the tip end of the second bonding portion other than the reinforcement bridging rib is equal to or less than 0.6 mm.

In this aspect, most of the bridging ribs are the standard bridging rib(s) which have narrowly limited bridging contact width. On the other hand, the limit of the bridging contact width of the reinforcement bridging rib(s) is set comparatively wide. Therefore, according to this aspect, peeling-off of the dashboard from the air bag door are surely prevented, while keeping the good visual appearance of the dashboard.

What is claimed is:

1. A resin made air bag door, comprising:
a main portion having a welding face to be attached to an inner surface of a dashboard by vibration welding, the thickness of the dashboard being equal to or less than 2.0 mm at a welding area corresponding to the welding face of the main portion;
a plurality of welding ribs formed on the welding face in a vibrating direction of the vibration welding; each of the plurality of welding ribs including a welding portion to be melted at the time of vibration welding and a bonding portion to be bonded to the inner surface of the dashboard, remaining at the time of vibration welding; and
at least one bridging rib formed on the welding face of the main portion and extending in a direction crossing across the plurality of welding ribs, wherein a width of a tip end of the bonding portion is equal to or less than 3 mm and the bridging rib is integrally formed with mutually neighboring welding ribs.

2. The air bag door according to claim 1,
wherein the width of the tip end of the bonding portion of the welding rib is equal to or less than 1 mm.

3. The air bag door according to claim 1,
wherein the width of the tip end of the bonding portion of the welding rib is equal to or less than 0.6 mm.

4. The air bag door according to claim 1,
wherein the bridging rib has a second welding portion to be melted at the time of vibration welding and a second bonding portion to be bonded to the inner surface of the dashboard, remaining at the time of vibration welding, wherein a width of a tip end of the second bonding portion is equal to or less than 3 mm.

5. The air bag door according to claim 1,
wherein the at least one bridging rib includes a plural number of bridging ribs and the mutually neighboring welding ribs and mutually neighboring bridging ribs are formed integrally to form a combined rib portion in a shape of a grid.

6. The air bag door according to claim 1,
wherein the bridging rib is arranged perpendicular to the vibrating direction of the vibration welding.

7. The air bag door according to claim 1,
wherein the main portion has a retainer portion having a cylindrical retainer main portion and a frame shaped flange portion integrally formed with the retainer main portion at a dashboard side end thereof, and a door portion swingably connected to the retainer portion and wherein,
the welding face and the plurality of welding ribs and the bridging ribs are formed at the flange portion and the door portion.

8. The air bag door according to claim 1,
wherein the main portion has a retainer portion having a cylindrical retainer main portion and a frame shaped flange portion integrally formed with the retainer main portion at a dashboard side end thereof and a door portion swingably connected to the retainer portion,
the welding face is formed at the flange portion and the door portion,
the flange portion is provided with a line of welding ribs arranged from one end of an inner periphery of the flange portion to one end of an outer periphery of the flange portion,
the line of the welding ribs includes a reinforcement welding rib arranged closest to the one end of the inner periphery of the flange, and wherein
a portion of the tip end of the bonding portion of the reinforcement welding rib has a width wider than any other tip end of the bonding portion of the line of welding ribs.

9. The air bag door according to claim 4,
wherein the main portion has a retainer portion having a cylindrical retainer main portion and a frame shaped flange portion integrally formed with the retainer main portion at a dashboard side end thereof and a door portion swingably connected to the retainer portion,
the welding face is formed at the flange portion and the door portion,
the flange portion is provided with a line of bridging ribs arranged from one end of an inner periphery of the flange portion to one end of an outer periphery of the flange portion,
the line of the bridging ribs includes a reinforcement bridging rib arranged closest to the one end of the inner periphery of the flange, and wherein
a portion of the tip end of the second bonding portion of the reinforcement bridging rib has a width wider than any other tip end of the second bonding portion of the line of bridging ribs.

10. The air bag door according to claim 8,
wherein the width of the portion of the tip end of the bonding portion of the reinforcement welding rib is equal to or less than 1 mm, whereas the width of the tip end of the bonding portion other than the reinforcement welding rib is equal to or less than 0.6 mm.

11. The air bag door according to claim 4,
wherein the width of the tip end of the second bonding portion of the bridging rib is equal to or less than 1 mm.

12. The air bag door according to claim 9,
wherein the width of the portion of the tip end of the second bonding portion of the reinforcement bridging rib is equal to or less than 1 mm, whereas the width of the tip end of the second bonding portion other than the reinforcement bridging rib is equal to or less than 0.6 mm.
